(19) United States
(12) Patent Application Publication
(10) Pub. No.: US 2019/0120163 A1
(43) Pub. Date: Apr. 25, 2019

(54) DUAL-FUEL INTERNAL COMBUSTION ENGINE

(71) Applicant: GE Jenbacher GmbH & Co. OG, Jenbach, Tirol (AT)

(72) Inventors: Michael V. HILLEBRECHT, Prague (CZ); Georg TINSCHMANN, Schwaz (AT); Dino IMHOF, Baden (CH)

(21) Appl. No.: 16/063,418

(22) PCT Filed: Dec. 15, 2016
(86) PCT No.: PCT/AT2016/060128

§ 371 Date: Nov. 13, 2018

(30) Foreign Application Priority Data
Dec. 29, 2015 (AT) A51111/2015

(51) Int. Cl. F02D 41/30; F02D 41/00; F02D 19/08; F02D 35/02

(52) U.S. Cl. CPC F02D 41/3064; F02D 35/027; F02D 19/081; F02D 41/0025

(57) ABSTRACT

A dual-fuel internal combustion engine is provided with at least one combustion chamber assigned to an intake valve for a gas-air mixture and to an injector for liquid fuel. A control device performs a switch-over in a switch-over mode, wherein an amount of energy supplied to the at least one combustion chamber by means of the gas-air mixture is changed, and an injected amount of liquid fuel and/or a time of the injection of the liquid fuel is changed. A sensor provides signals characteristic of occurring knock in the at least one combustion chamber, wherein the control device performs the switch-over with evaluation of the sensor signals. The control device performs the evaluation of the sensor signals based on the injected amount of liquid fuel in the at least one combustion chamber. If knock occurs above a specified first knock threshold value, the control device performs knock-reducing measures if the injected amount of liquid fuel lies below a specified liquid fuel threshold value and/or if knock occurs above a specified first knock threshold value, the control device does not perform knock-reducing measures or performs knock-reducing measures only in a restricted manner if the injected amount of liquid fuel lies above a specified liquid fuel threshold value and if the knock lies below a specified second threshold value.

### TECHNOLOGY FIELD

The present disclosure relates to a dual-fuel internal combustion engine with the features of the preamble of claim 1 and a method for switch-over of a dual-fuel internal combustion engine with the features of the preamble of claim 8.

### BACKGROUND

Dual-fuel internal combustion engines are typically operated in two operating modes. A distinction is made between an operating mode with a primary liquid fuel supply (“liquid operation” for short; in the case of the use of diesel as a liquid fuel, it is called “diesel operation”) and an operating mode with a primarily gaseous fuel supply, in which the liquid fuel serves as a pilot fuel for initiating combustion (known as “gas operation”, “pilot operation”, or “ignition jet operation”). An example of the liquid fuel is diesel. It could also be heavy oil or another self-igniting fuel. An example of the gaseous fuel is natural gas. Other gaseous fuels, such as biogas etc. are also suitable.

In pilot operation, a small amount of liquid fuel is introduced as a so-called pilot injection into a combustion chamber of a piston cylinder unit. As a result of the conditions prevailing at the time of injection, the introduced liquid fuel ignites and detonates a mixture of gaseous fuel and air present in the combustion chamber of the piston cylinder unit. The amount of liquid fuel in a pilot injection is typically 0.5-5% of the total amount of energy supplied to the piston cylinder unit in a work cycle of the internal combustion engine.

To clarify the terms, it is defined that the internal combustion engine is operated in pilot operation or in liquid operation. With regard to the control device, the pilot operation of the internal combustion engine is referred to as a pilot mode, and a liquid operation of the internal combustion engine is referred to with regard to the control device as a liquid mode. In addition, there is a mixed operation.

The substitution rate indicates the proportion of the energy supplied to the internal combustion engine in the form of the gaseous fuel. Substitution rates of between 98 and 99.5% are targeted. Such high substitution rates require a design of the internal combustion engine, for example in terms of the compression ratio as it corresponds to that of a gas engine. The sometimes conflicting demands on the internal combustion engine for a pilot operation and a liquid operation lead to compromises in the design, for example in terms of the compression ratio.

U.S. Pat. No. 7,913,673 describes a generic internal combustion engine and a generic method. The switch-over is performed by evaluating the signals of a knock sensor as close as possible to the knock limit, so that the switch-over can be performed as quickly as possible.

The WO 2013075234 describes a control unit for a dual-fuel internal combustion engine. Here, it is described in more detail that the gas-diesel ratio can be calculated in normal operation by a control unit in dependence of a measured parameter and consequently the actually injected diesel and gas amount can be adjusted to the calculated value by the control unit.

### SUMMARY

The object of the disclosure is to provide a dual-fuel internal combustion engine of this type and a method of this type for switch-over of a dual-fuel internal combustion engine, in which the switch-over can be done even faster than in the prior art.

This object is achieved by a dual-fuel internal combustion engine with the features of claim 1 and a method for switch-over of a dual-fuel internal combustion engine with the features of claim 8. Advantageous embodiments of the disclosure are defined in the dependent claims.

Occurring knock, when the substitution rate is relatively high (e.g. higher than 70%), is caused by the gas-air mixture present in the combustion chamber at that substitution rate with a high energy fraction. Due to the combustion characteristics of the gas-air mixture, this has far higher negative impact than occurring knock at a relatively low substitution rate (such as less than 60%), because the energy fraction of the gas-air mixture at this substitution rate is low.

The disclosure not only takes into consideration the signals of the sensor during switch-over, which are characteristic for knock occurring in at least one combustion chamber (hereinafter “knock signal” for short), but it also takes into consideration the injected amount of liquid fuel in the at least one combustion chamber.

If, for example, knock occurs at a relatively small injected amount of liquid fuel, the knock occurs at a gas-air mixture with a high energy fraction and measures must be taken which reduce the knock (if this is above a knock threshold value), resulting in a slowdown of the switch-over.

On the other hand, if knock occurs at a relatively high injected amount of liquid fuel, this is classifiable as less dangerous. Either no or only a few severe measures must be taken, which reduce the knock, or these measures only need to be taken when the knock intensifies. In this case, the slowdown of the switch-over does not occur or not as severely or only later.

According to the disclosure, it is provided that the control device is designed, if knock occurs above a specified first knock threshold value, to perform knock-reducing measures if the injected amount of liquid fuel lies below a specified liquid fuel threshold value and/or that the control device is designed, if knock occurs above a specified first knock threshold value, to not perform knock-reducing measures or to perform knock-reducing measures only in a restricted manner if the injected amount of liquid fuel lies above a specified liquid fuel threshold value and if the knock lies below a specified second threshold value. The liquid fuel threshold value is in an embodiment specified as mass value in dependence of a substitution rate and a load of the internal combustion engine. In this sense, a plurality of liquid fuel threshold values exists.

Knock-reducing measures are e.g.:

Increasing of an excess air coefficient of the gas-air mixture

Decreasing of an inlet temperature of the gas-air mixture, if this is possible at the present humidity, without a resulting condensing out

Reducing of the amount of energy by reducing the amount of injected liquid fuel (this measure can be taken cylinder-specific)

Changing the time of injection of the liquid fuel to later (this measure can be taken cylinder-specific)

These measures can be taken individually or in any combination.

If knock occurs, which must be counterbalanced, only in isolated combustion chambers of the internal combustion engine, it is in an embodiment provided for these combustion chambers to reduce the amount of energy of injected liquid fuel and/or change the time of injection of the liquid fuel to later.

If knock occurs, which must be counterbalanced, not only in isolated combustion chambers of the internal combustion engine, it is in an embodiment provided alternatively or in addition to the measures described in the previous paragraph to increase the excess air coefficient of the gas-air mixture or to decrease the inlet temperature of the gas-air mixture.

It can be provided that the control device is designed to calculate the injected amount of liquid fuel from the variables of injection start, injection duration, injection pressure.

It can be provided that the control device is designed to perform the evaluation of the signals of the sensor taking into consideration the supplied amount of liquid fuel such that a substitution rate is calculated while also taking into consideration a current load of the internal combustion engine. Thus, the current load is taken into consideration by means of the substitution rate. Then it can be provided that the control device is designed to perform knock-reducing measures, when knock occurs, if the substitution rate is greater than a specified substitution rate threshold value.

Typically, an internal combustion engine comprises a plurality of piston cylinder units with combustion chambers. The disclosure may be implemented on a cylinder-specific basis, i.e. for each cylinder, independent of the other cylinders.

The disclosure can in an embodiment be used in a stationary internal combustion engine, for marine applications or mobile applications such as so-called “non-road mobile machinery” (NRMM), in an embodiment designed as a reciprocating piston engine. The internal combustion engine can be used as a mechanical drive, e.g. for operating compressor systems or coupled with a generator to a genset for generating electrical energy. The internal combustion engine in an embodiment comprises a plurality of combustion chambers with corresponding intake valves and injectors. Each combustion chamber can be controlled individually.

### BRIEF DESCRIPTION OF THE DRAWINGS

FIG. 1 shows schematically the logical structure of a control device of an internal combustion engine according to the disclosure.

FIG. 2 shows schematically the structure of an internal combustion engine according to the disclosure.

### DETAILED DESCRIPTION

An exemplary embodiment of the disclosure will be discussed with reference to the Figures.

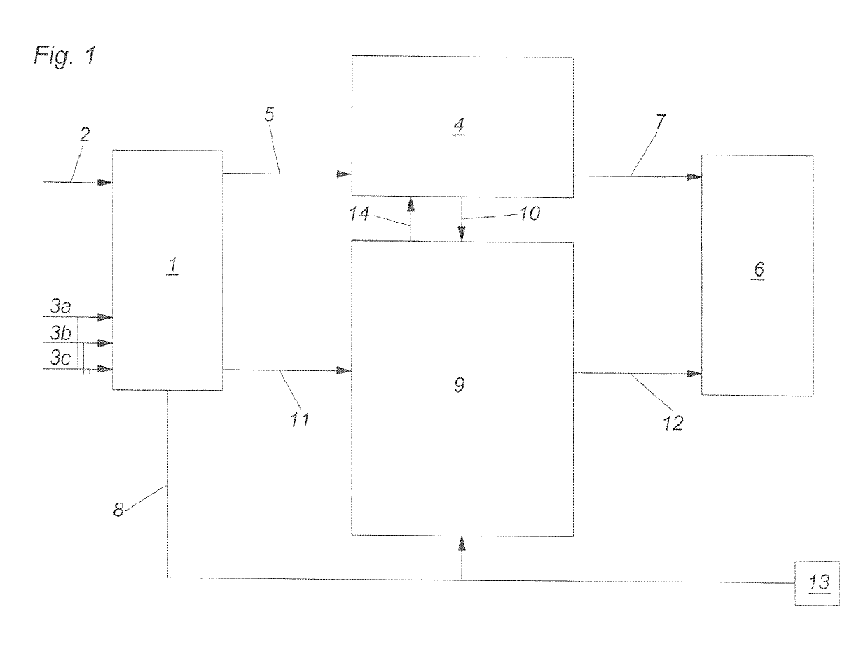

FIG. 1 shows schematically the logical structure of a control device of an internal combustion engine according to the disclosure. A wide variety of measuring signals of the internal combustion engine are supplied to an input block 1, particularly a wide variety of operating data (speed, torque, charge-air pressure, inlet temperature of the air, gas mass, air mass, . . . ) via the summarily represented line 2 and via lines 3a to 3c all that data, by which the control device can calculate the injected amount of liquid fuel (start of inj ecti on, injection duration, injection pressure—e.g. rail pressure).

The input block 1 transmits via line 5 signals to a dual-fuel unit 4, which in dependence of a desired substitution rate (e.g. 90%) determines the required operating parameters of the internal combustion engine and controls based on the signals of line 5 whether the actual values of these parameters correspond to the target values.

The dual-fuel unit 4 transmits control signals to a combustion control unit 6, which adjusts the operating parameters of the internal combustion engine (start of the injection, injection duration, injection pressure—e.g. rail pressure, speed, torque, charge-air pressure, inlet temperature of the air, gas mass, excess air coefficient, . . . ).

Signals from the input block 1 are transmitted to a switch-over unit 9 via line 11, which in an embodiment is active only during the switch-over (an appropriate activation signal is transmitted from the dual-fuel unit 4 via line 10) and which is also supplied with signals of a knock sensor 13 via line 8.

During the switch-over, the switch-over unit 9 uses the signals of a knock sensor 13 to assess different situations:

Did the gas-air mixture with a desired excess air coefficient arrive in the cylinder considered?

Is the signal of a knock sensor 13 in accordance with a value which is to be expected based on the amount of liquid fuel for the desired substitution rate?

Is a first knock threshold value exceeded?

This assessment can be transmitted to the dual-fuel unit 4 via line 14. Alternatively, the assessment can be transmitted immediately to the combustion control unit 6 via line 12.

If the switch-over unit 9 concludes based on the above logic that are knock-reducing measure must be taken, it transmits a corresponding signal via line 12 to the combustion control unit 6.

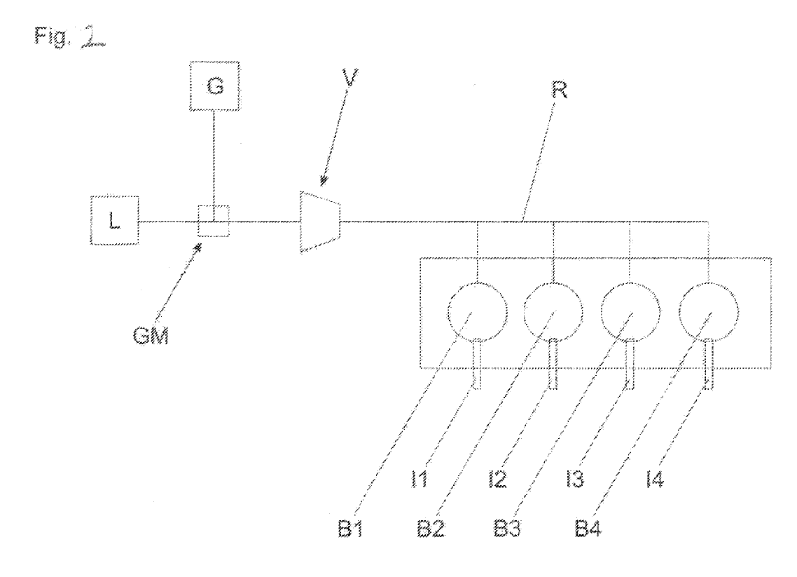

FIG. 2 shows schematically the structure of an internal combustion engine according to the disclosure.

In this example, it has four combustion chambers B1 to B4, which can be supplied with liquid fuel, in this case diesel, via the injectors I1 to I4. The intake valves for the gas-air mixture are not shown.

To create the gas-air mixture, a central gas mixer GM is provided, which is connected to an air supply L and a gas reservoir G, e.g. a tank. Via a gas-air mixture supply R, the gas-air mixture produced in the central gas mixer GM is fed to the combustion chambers B1 to B4. Downstream of the gas mixer GM, a compressor V of a turbocharger (mixed-charged internal combustion engine) is also provided. However, the gas mixer GM could also be arranged downstream of the compressor V in the air supply (air-charged internal combustion engine). The number of combustion chambers B1 to B4 is purely exemplary.

The disclosure can be used in dual-fuel internal combustion engines with 2, 4, 6, 8, 10, 12, 14, 16, 18, 20, 22 or 24 combustion chambers.

What we claim is:

1. A dual-fuel internal combustion engine comprising:
at least one combustion chamber assigned to an intake valve for a gas-air mixture and to an injector for liquid fuel;
a control device operable to perform a switch-over in a switch-over mode, wherein in the switch-over
an amount of energy supplied to the at least one combustion chamber via the gas-air mixture is changed, and
an injected amount of liquid fuel and/or a time of injection of the liquid fuel is changed; and
a sensor operable to generate signals characteristic of occurring knock in the at least one combustion chamber; wherein the control device is operable to perform the switch-over with evaluation of the sensor signals
based on the injected amount of liquid fuel in the at least one combustion chamber, such that if knock occurs above a specified first knock threshold value, to perform knock-reducing measures if the injected amount of liquid fuel lies below a specified liquid fuel threshold value and/or if knock occurs above theft specified first knock threshold value, to not perform knock-reducing measures or to perform only restricted knock-reducing measures if the injected amount of liquid fuel lies above the specified liquid fuel threshold value and if the knock lies below a specified second threshold value.

2. The dual-fuel internal combustion engine according to claim 1, wherein the control device determines the liquid fuel threshold value in dependence on a substitution rate and a load of the internal combustion engine.

3. The dual-fuel internal combustion engine according to claim 1, wherein a plurality of liquid fuel thresholds values is determined in dependence on a substitution rate.

4. The dual-fuel internal combustion engine according to claim 1, wherein the control device performs the evaluation of the sensor signals based on the iniected amount of liquid fuel such that a substitution rate is calculated based on a current load of the internal combustion engine.

5. The dual-fuel internal combustion engine according to claim 1, wherein the control device performs knock-reducing measures, if knock occurs above the specified first knock threshold value, if a substitution rate is greater than a specified substitution rate threshold value.

6. The dual-fuel internal combustion engine according to claim 1, wherein the control device calculates the injected amount of liquid fuel from variables of injection start, injection duration, and injection pressure.

7. The dual-fuel internal combustion engine according to claim 1, wherein the control device comprises:
an input block, to which measuring signals of the internal combustion engine can be supplied;
a dual-fuel unit, which in dependence on a desired substitution rate, determines the required operating parameters of the internal combustion engine and controls actual values of the operating parameters corresponding to target values of
a combustion control unit to adjust the operating parameters of the internal combustion engine, and
a switch-over unit.

8. A method for switch-over of a dual-fuel internal combustion engine, comprising:
changing an amount of energy supplied to an at least one combustion chamber through a gas-air mixture; and
changing an injected amount of liquid fuel and/or a time of injection of the liquid fuel;
wherein the switch-over occurs based on an evaluation of signals characteristic for knock occurring in the at least one combustion chamber, the evaluation of the signals based on the injected amount of liquid fuel in the at least one combustion chamber, such that, if knock occurs above a specified first knock threshold value, at least one knock-reducing measure is performed, if the injected amount of liquid fuel lies below a specified liquid fuel threshold value and/or if knock occurs above theft specified first knock threshold value, no knock-reducing measure is performed or at least one restricted knock-reducing measure is performed, if the injected amount of liquid fuel lies above the specified liquid fuel threshold value and if the knock lies below a specified second threshold value.
